(19) United States
(12) Patent Application Publication
(10) Pub. No.: US 2023/0315375 A1
(43) Pub. Date: Oct. 5, 2023

(54) REMOTELY CONTROLLED DISPLAY SYSTEM AND GUIDANCE METHOD USING REMOTELY CONTROLLED DISPLAYS

(71) Applicant: MariElla Labels Oy, Vantaa (FI)

(72) Inventor: Göran SUNDHOLM, Tuusula (FI)

(73) Assignee: MariElla Labels Oy, Vantaa (FI)

(21) Appl. No.: 18/024,910

(22) PCT Filed: Sep. 2, 2021
(86) PCT No.: PCT/FI2021/050592

§ 371 Date: Mar. 6, 2023

(30) Foreign Application Priority Data
Sep. 7, 2020 (FI) 20205865
Sep. 7, 2020 (FI) 20205866
Sep. 18, 2020 (FI) 20205900

(51) Int. Cl. G06F 3/14; G09G 3/32; G09F 3/20

(52) U.S. Cl. CPC G06F 3/1423; G09G 3/32; G09F 3/208; G09G 2330/021

(57) ABSTRACT

A method for controlling remotely controlled displays, such as electronic price tags, of a remotely controlled display system, and a remotely controlled display system including at least one base station and a plurality of remotely controlled displays, such as electronic price tags. The remotely controlled displays are arranged in premises, such as a store, and include a light source, e.g. an LED light source. The system is adapted to provide guidance to people, such as emergency exit guidance, by turning on and/or off the light sources of the remotely controlled displays in a pre-determined manner.

### FIELD OF THE INVENTION

The invention relates to a remotely controlled display system and a guidance method using remotely controlled displays.

### BACKGROUND

Traditionally, price information on price tags in stores is changed manually whenever the price of a product changes. The new prices are printed on paper or similar material and these tags with their new price markings are manually placed in the space reserved for the price tags on the shelves in the sales premises. This means that the employee must first find the correct location for the price tag to be updated, remove and discard the old price tag and then insert the new price tag. One disadvantage of this solution is that the solution is very laborious and the possibility of errors is high. In the event of an error, a situation may arise in which there is a conflict between the price information on the shelf and the price information in the point-of-sale system.

In order to avoid the above-mentioned drawbacks, electronic systems have been developed in which shelves or products have electronic display units with electronic displays where product price information can be updated centrally from the system control center. This makes it much easier and quicker to update price information. Information on the displays can be updated in a wired or wireless manner, depending on the system. The problem with wired systems is that a wired connection must be provided for each display for the transfer of data and possibly also for power supply. Since there are quite a number of displays in, say, a normal grocery store, there also needs to be a lot of wires, which causes problems and restrictions on the placement of price displays, for example.

Wireless systems do not require complex wiring, but, on the other hand, their battery-operated price displays require transceivers that allow them to communicate with the system control unit through appropriate interfacing means.

Various systems are known for guiding people in emergency situations, such as a fire, to emergency exits of various buildings or ships. These include various emergency exit lighting systems and emergency exits marked with reflective paint or tape, for example.

For example, separate guidance lights designed for emergency exit use are known, in which the light sources are affixed consecutively in the shape of a strip. The light sources on the strip are arranged to light up in an emergency and to guide people and illuminate the way out. Many applications, such as shopping malls, stores, hotels, or passenger ships, have designated escape routes in emergencies that people should follow in evacuation situations. In emergencies, people often do not behave as planned nor follow pre-determined exit routes. There can be many reasons for this. People may not be aware of emergency exit routes and the related signage. In the event of a fire, the signs may be covered in smoke and become invisible. In addition, in emergencies, people prefer to use routes that are familiar to them. On the other hand, in the event of a fire, a pre-determined escape route may be impossible to use due to the location of the threat (such as fire, flood, water damage, violence, etc.) that caused the need to escape, so that known solutions may steer people in the wrong direction or even toward the threat.

The object of the present invention is to provide a completely new type of solution, by means of which the disadvantages of the known solutions are reduced.

### SUMMARY OF THE INVENTION

The purpose of the solution according to the invention is to eliminate the problems of the prior art. The remotely controlled display system according to the invention is characterized by what is mentioned in the characterizing part of claim 1. The remotely controlled display system according to the invention is further characterized by what is mentioned in claims 2-10. The method according to the invention is characterized by what is mentioned in the characterizing part of the method claim 11. The method according to the invention is also characterized by what is mentioned in the characterizing parts of the method claims 12-20.

Accordingly, the invention relates to a remotely controlled display system, which may be, for example, an electronic price tag system. The system comprises at least one base station and a plurality of remotely controlled displays arranged in premises, such as a store or warehouse. The remotely controlled displays comprise a light source, e.g. an LED light source. The system is adapted to provide guidance to people, such as emergency exit guidance, by turning on and/or off the light sources of the remotely controlled displays in a pre-determined manner.

The invention also relates to a method for controlling displays, such as electronic price tags, of a remotely controlled display system, in a remotely controlled display system, which comprises at least one base station and remotely controlled displays that are arranged in premises, such as a store or warehouse, the remotely controlled displays comprising a light source, e.g. an LED light source. In the method, the system provides guidance to people, such as emergency exit guidance, by turning on and/or off the light sources of the remotely controlled displays in a pre-determined manner.

In the description of the invention, many embodiments refer to an electronic price tag system, but the solution and the embodiments presented in the application can be generally used to control remotely controlled displays and for a remotely controlled display system. Thus, in the embodiments presented in the application which comprise electronic price tags, remotely controlled displays can be used instead, such as remotely controlled displays with corresponding features. Also in the embodiments presented in the application which comprise an electronic price tag system, a remotely controlled display system, such as a remotely controlled display system with corresponding features, can be used instead.

The solution according to the invention can utilize a light source in a remotely controlled display, such as an electronic price tag, for guidance. The solution of the invention can be used to control remotely controlled displays, such as electronic price tags, to guide, steer or warn in various situations, such as in the event of a fire, where the light sources of the remotely controlled displays such as electronic price tags arranged consecutively and/or side-by-side are controlled to achieve the desired guidance effect.

In one embodiment of the invention, the light source of the electronic price tag can be used for other purposes when the guidance function is not active, such as to indicate the need for an inventory of the product in question, as a product collection guide, to draw attention to a special offer, or for other desired use. In the solution of the invention, the light source of the electronic price tag can be used, for example, in a situation where premises, such as a store, warehouse or property, has to be evacuated in an emergency. In one solution of the invention, the exit guidance can be activated, for example, on the basis of a fire detected in the premises.

In one embodiment of the invention, the light sources of the electronic price tags are switched on and kept lit when the guidance is activated, i.e. in a situation where people need to evacuate the premises.

In one embodiment of the invention, the light sources of the electronic price tags can guide dynamically when the guidance function is active, i.e. when people need to evacuate the premises. In this case, the guidance can indicate the correct exit direction to the persons in the premises by switching on and off the light sources of the electronic price tags. The flashing order can be determined, for example, based on the shelf map and/or the location information of the electronic price tag.

In one embodiment of the invention, the electronic price tag system is adapted to guide using substantially all electronic price tags in the premises or only the electronic price tags placed on a lower level, such as the lowest shelves.

In one embodiment of the invention, the electronic price tag system may comprise or be connected to other guidance means, such as guiding light source strips, such as LED light source strips, or light signs or larger displays in the premises. Other guidance means can be used, for example, in places where electronic price tags are too sparsely located to provide a reliable guidance effect. Larger displays and light signs can be used in normal mode for advertising or information purposes, for example.

An electronic price tag system according to one embodiment of the invention is a two-way price tag system, e.g. a system communicating by radio or light sources and comprising base stations adapted to communicate with electronic price tags. The electronic price tag system is also used to send the guidance activation signal or activation command to the electronic price tags.

In one embodiment of the invention, the system comprises a separate guidance display comprising an illuminated sign, such as an arrow sign, and/or light sources. The separate guidance display is adapted to guide in the desired direction by means of the sign and/or light sources. In one embodiment of the invention, the separate guidance display is arranged to communicate with a remotely controlled display system, such as an electronic price tag system. In one embodiment of the invention, the separate guidance display may comprise similar fastening means for attaching the guidance display as the remotely controlled display, such as an electronic price tag. In one embodiment, other displays and separate guidance displays are attached to the edges of the shelves, for example to a mounting rail.

With a separate guidance display, the guidance effect can be improved and, for example, in the case of remotely controlled displays for static guidance, dynamic guidance can be easily added to the system by adding separate guidance displays to the system. In one embodiment of the invention, as the displays communicate with the system in the same manner as other remotely controlled displays in the system, there is no need to acquire and install new components in addition to the guidance displays.

One embodiment of the invention also relates to an exit guidance system. The system comprises portable devices or the system is connected to portable devices such as mobile telephones, and the system and the devices comprise communication means for communicating with each other. The portable devices comprise software, and a floor plan of the premises is stored in the system and/or software. The system is arranged to implement guidance of people, such as emergency exit guidance, by means of an application installed on portable devices. The floor plan may comprise location information of objects and/or structures in the premises, such as location information of shelves in a store.

In one embodiment of the invention, the exit guidance system is adapted to send an exit command to the device, and, in response to the command, the device is adapted to start exit guidance in the software, shown on the display of the device. The exit command may include information related to the exit guidance, such as the exit route, the exit door, and/or the location of a fire.

In one embodiment of the invention, the exit guidance system and/or software are adapted to guide the user of the device out of the premises, e.g. to the exit and/or emergency exit of the premises, such as the nearest exit door. Using the software in the device, the system can guide people based on indications of fire detectors in the premises, e.g. away from the location of a fire detector that has detected a fire.

In one embodiment of the invention, the exit guidance system and/or software are adapted to generate guidance by showing on the display of the device a route to the exit, wherein the route is adapted to be drawn as a line and/or consecutive and/or adjacent symbols such as dots or circles. The guidance can be performed by making the consecutive and/or adjacent symbols “run”, e.g. by changing their color and/or making the symbols smaller and/or bigger. The symbols may have two states, a normal state and a guidance state, and the impression of motion is created by controlling the symbols in groups so that when the appearance of the next symbol enters the guidance state, e.g. by changing the color and/or making the symbol smaller and/or bigger, the appearance of the preceding symbol enters the normal state.

One embodiment of the invention also relates to an exit guidance method that may be used in an exit guidance system comprising portable devices or the system is connected to portable devices such as mobile telephones, and the system and devices comprise communication means for communicating with each other, wherein the portable devices comprise software, and wherein a map or floor plan of the premises has been stored in the system and/or software. The method implements the guidance of people, such as emergency exit guidance, by means of an application installed on portable devices in the system.

In one embodiment of the invention, the system may comprise both the features of a remotely controlled display system and the features of an exit guidance solution implemented by the device (e.g., the exit guidance system and/or exit guidance method described in the application).

The remotely controlled display system and method according to the invention have a number of significant advantages. The method and system according to the invention are able to effectively direct people out along exit routes in an emergency situation when the light sources of remotely controlled displays, such as electronic price tags, are controlled in a desired manner, wherein people are guided towards the exit routes by means of light. The solution of the invention also does not require separate systems because both the price display functions and the emergency exit instructions are integrated in one and the same system. In this way, effective emergency exit guidance can be easily implemented in all premises. This improves safety while keeping installation and hardware costs low.

Portable device based guidance according to the invention also has numerous advantages. This solution, too, allows people to be effectively guided out along exit routes in an emergency. With the solution of the invention, the users do not need separate devices, but the guidance can be provided on users' devices, which they are carrying in the premises anyway. In many cases, a device for personal use can also guide a person more reliably than signs in the premises, because, for example, smoke can make it difficult to see the signs. In addition, with the system according to the invention, the exit routes can be easily modified and the exit guidance in the user's device does not require any hardware installation, even if the exit routes and/or the furnishing of the premises undergo changes.

### BRIEF DESCRIPTION OF THE DRAWINGS

The invention is below described in closer detail with the aid of examples and with reference to FIGS. 1 to 12, wherein

FIG. 1 shows, in a simplified form, an electronic price tag system according to an embodiment of the invention,

FIG. 2 shows, in a simplified form, a base station of an electronic price tag system according to an embodiment of the invention in a store,

FIG. 3 shows electronic price tags of an electronic price tag system according to an embodiment of the invention in a store,

FIG. 4 shows in a simplified diagram the operation of an electronic price tag system according to an embodiment of the invention in a situation where the area is to be evacuated,

FIG. 5 shows in a simplified diagram the operation of an electronic price tag system according to an embodiment of the invention in a situation where the area is to be evacuated,

FIG. 6 shows in a simplified diagram the operation of an electronic price tag system according to an embodiment of the invention in a situation where the area is to be evacuated

FIG. 7 shows in a simplified diagram the operation of an electronic price tag system according to an embodiment of the invention in a guidance situation,

FIG. 8 shows in a block diagram the operation of an electronic price tag system according to the invention,

FIG. 9 shows a portable device according to an embodiment of the invention and an application running therein in a fire situation,

FIG. 10 shows a portable device according to an embodiment of the invention and an application running therein in a fire situation,

FIG. 11A shows an embodiment of the invention, which comprises a guidance display,

FIG. 11B shows a guidance display according to an embodiment of the invention when guiding in the first direction,

FIG. 11C shows a guidance display according to an embodiment of the invention when guiding in the second direction, and

FIGS. 12A-E show a guidance display according to an embodiment of the invention.

### DETAILED DESCRIPTION OF THE INVENTION

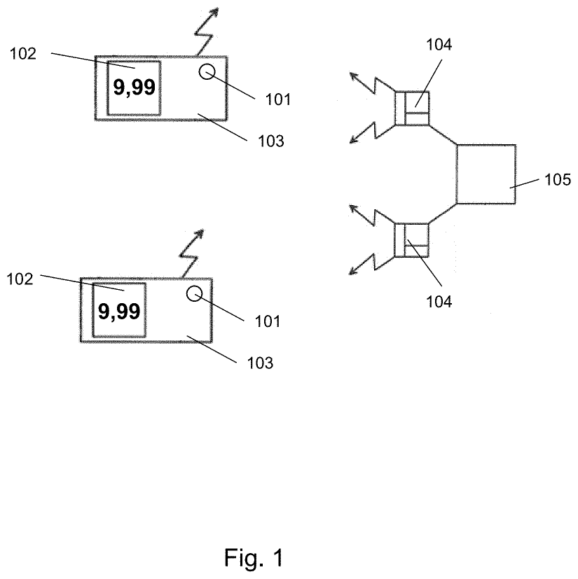

FIG. 1 shows diagrammatically and in a simplified manner an arrangement according to the invention which can be used e.g. in a store or in similar sales premises. Electronic price tags 103 can be affixed to the shelves in the premises. The electronic price tag display is arranged to display product-related information, such as price, product name, and possibly some other product-related information. Electronic price tags can communicate with the rest of the system via base stations 104.

The body of the electronic price tag may be hard or elastic and flexible in material and structure. The electronics of the electronic price tag can be placed inside or in connection with the body of the tag. The display of the electronic price tag is equipped with display segments or pixels. The electronic price tag may have an opening or other attachment means for attaching the electronic price tag to a desired location, e.g., the edge of a shelf.

An electronic price tag system according to an embodiment of the invention may include, in addition to electronic price tags, at least communication means, such as a central unit 105 with communication means, through which updated price information and other control information for electronic price tags 103 can be sent and received via base stations 104 in the system. In addition, scanners at checkouts, which are connected to the cash register system and scan the products, may be connected to the system, wherein the cash register system and the electronic price tags always have the same and up-to-date product price information. The central unit 105 may be further connected to other control and support systems. Arrows represent the wireless connection between the base stations 104 and the electronic price tags 103.

The electronic price tag also comprises a light source 101 that can be turned on and off as desired, controlled by the electronic price tag and/or electronic price tag system. The light sources of the electronic price tags may preferably be, for example, light emitting diodes, LED light sources, arranged in connection with the electronic price tag, for example in some of the electronic price tags or all electronic price tags. The light source or light sources may be arranged on different sides of the electronic price tag, for example on the front surface of the electronic price tag, whereby the light source is visible on the front side of the electronic price tag attached to the edge of the shelf. The light source may also be arranged at the top of the body of the electronic price tag, e.g. so as to point upwards, at the bottom, e.g. so as to point downwards, and/or at the back, e.g. so as to point to the back of the electronic price tag. In one embodiment of the invention, the electronic price tag may comprise a plurality of light sources.

An electronic price tag used in the system according to an embodiment of the invention comprises communication means by means of which it can communicate with the electronic price tag system.

The following is a more detailed example of what an electronic price tag can be like. Affixed to the electronic price tag there are a display controller connected to a display, a transmitter, a receiver and a power supply, which is, for example, a standard battery. The power supply is arranged to provide electrical energy to the electronic price tag and its display controller. Through the receiver and the display controller, the price information or other information shown on the display can be updated wirelessly from the central unit. In one embodiment of the invention, the light source of the electronic price tag can also be controlled from the central unit. In this exemplary embodiment, the update and control information is transmitted by radio waves, but other communication methods are possible. In one exemplary embodiment, each electronic price tag may form a thin price tag resembling a paper price tag with a display, wherein the required product prices with other necessary characters are formed by changing the color of the display segments. The color of the display segments and background is changed by an electric field generated by an electric current, as described above.

The display of the electronic price tag used in the system according to the invention can be implemented, for example, as an electronic laminate display that produces a thin price tag resembling a paper price tag with a display, wherein product-related information, such the product prices with other necessary characters, are formed by changing the color of the display segments. One layer of the display could be an active ink layer, for instance. The ink layer contains a plurality of liquid-filled microcapsules with, for example, positively surface-charged, substantially black particles and negatively surface-charged, substantially white particles, with their location in the microcapsules being controlled by an electric field so that, at the desired display segments, the black particles are at the top, making those display segments look black when viewed from above, and at the other display segments, the white particles are at the top, making these display segments look light when viewed from above. The background of the display consists of the same microcapsules, so for example the price information can be presented in dark numbers against a light background, or vice versa if desired. The electrophoretic microcapsule display laminate disclosed in Finnish Patent Application No. FI 20050192 can be used as such a display. Other types of displays, such as color displays, can also be used in the solution of the invention.

An electronic price tag system according to one embodiment of the invention is a two-way price tag system, e.g. a system communicating by radio or light sources and comprising base stations adapted to communicate with electronic price tags. In this case, the electronic price tags and the base stations comprise communication means adapted to communicate with each other. In one embodiment of the invention, the system uses an infrared-based communication technology which, due to its speed, is well suited to the environment of the invention.

Through the communication means, the base station can send commands to the electronic price tags and/or receive information from the electronic price tags. The electronic price tag system is also used to send the guidance activation signal or activation command to the electronic price tags.

After the sending of the command, the central unit of the equipment can forward information about the changes that have occurred and/or have been made in the state of the electronic price tag via the network, e.g. to a POS system. The equipment can also receive information to be sent to a certain electronic price tag via the network, e.g. from a POS system. Such information may include, for example, price information displayable on the electronic price tag display, shutdown information, activation of guidance, deactivation of guidance, electronic price tag battery status, type of guidance, and/or light source status.

The application of the invention is not limited to price displays using a display technology as described above, but it is clear that the price displays per se can be implemented using any known technology. The solution described above focuses specifically on how the communication between the electronic price tags and the electronic price tag system can be efficiently arranged in one exemplary solution.

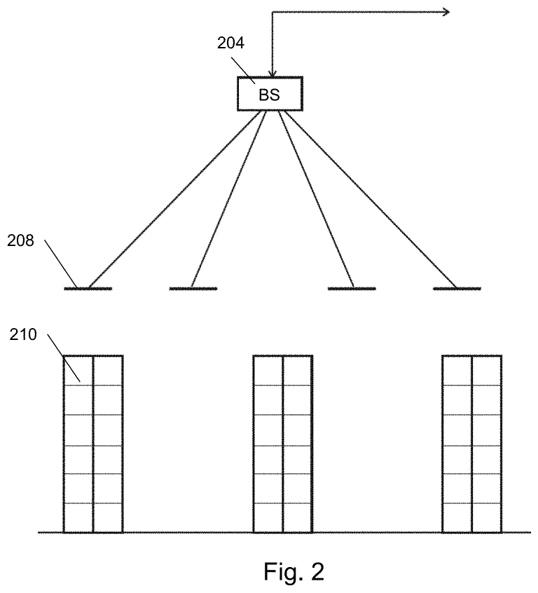

FIG. 2 is a simplified representation of a base station 204 of an electronic price tag system in accordance with embodiments of the invention. The base station according to these embodiments comprises communication means for two-way, e.g. radio-frequency, communication with electronic price tags, the electronic price tags being attached to the edges of shelves 210, for example. In one embodiment, the base station 204 is adapted to communicate with the electronic price tags as described above so that the electronic price tags reflect back the transmission received from the base station.

The base stations of the electronic price tag system can be arranged in premises such as a store so that communication between the base station and, for example, electronic price tags attached to the edges of the shelves is successful, e.g. so that the field strength is high enough for reliable communication. The base station may comprise a plurality of antennas 208 which may be arranged at desired locations such as near or above the shelves and/or aisles.

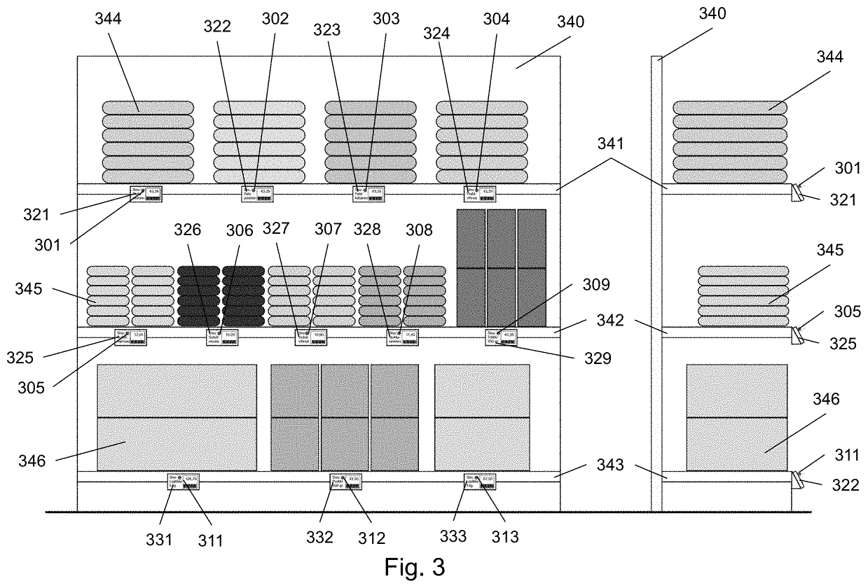

FIG. 3 shows an embodiment according to the invention in which the price tags of the electronic price tag system are arranged on the edges of the different levels 341, 342, 344 of a shelf 340. Products 344, 345, 346 can be arranged on the shelves. The edges of the shelves may have places and/or means for affixing an electronic price tag. The electronic price tags shown in FIG. 3 comprise a single light source, such as an LED light source, arranged in front of the electronic price tags to point the light produced by the light source to the front side of the electronic price tag. In one embodiment, the color of the light produced by the light source may be changed.

In the example of FIG. 3, four different products and associated electronic price tags 321, 322, 323, 324 are placed on the top shelf 341, with each electronic price tag comprising a light source 301, 302, 303, 304, respectively. Placed on the middle shelf 342 are five different products and associated electronic price tags 325, 326, 327, 328, 329, with each electronic price tag comprising a light source 305, 306, 307, 308, 309, respectively. Placed on the bottom shelf 343 are three different products and associated electronic price tags 331, 332, 333, with each electronic price tag comprising a light source 311, 312, 313, respectively.

In one embodiment of the invention, the electronic price tag system is adapted to switch on the light sources of the electronic price tags and keep them lit when the premises need to be evacuated, e.g. based on an indication by fire detectors. In this case, the light sources of the electronic price tags can stay lit statically throughout the time when the guidance function is to remain active. Typically, static lighting is produced such that all or at least a portion of the light sources of the electronic price tags are switched on to produce light at the same time.

In one embodiment of the invention, the electronic price tag system is adapted to flash the light sources of adjacent electronic price tags. An impression of movement can be created by controlling the light sources of the electronic price tags in groups. Control for the light sources can be implemented, for example, in such a way that when the light source of the next electronic price tag is switched on, the light source of the preceding electronic price tag is switched off. In one embodiment of the invention, control for the light sources can be implemented in such a way that the light sources of a group of several electronic price tags (e.g. a group of two or three electronic price tags) are switched on, the light sources of the preceding group of electronic price tags are switched off.

In one embodiment of the invention, the guiding effect is produced by the light sources of adjacent electronic price tags. Such a solution can be used, for example, if the electronic price tag has one light source only. If the electronic price tag comprises multiple light sources, the guiding effect, i.e. the impression of movement, can be produced by means of the light sources of one electronic price tag and/or jointly by means of the light sources of adjacent electronic price tags.

In one embodiment of the invention, the light sources of the electronic price tag may have at least two modes: a static mode and a dynamic mode in which the light sources are switched on and off so as to create the impression of movement. In this embodiment, the light sources of the electronic price tags can be controlled to switch between dynamic and static modes.

In one embodiment of the invention, the electronic price tag system is adapted to guide using substantially all electronic price tags in the premises. In one embodiment of the invention, the electronic price tag system is adapted to guide using only the electronic price tags placed on the lowest level, such as the lowest shelves. In the example of FIG. 3, the light sources 311, 312 and 313 would in this case be used for guidance.

In one embodiment, in addition to or instead of the above-mentioned light signs, an arrow may be used in addition to the price and product information on the display to indicate the direction of exit. In one embodiment, the display or arrow pattern may be illuminated.

An example of how to create a guidance effect is explained below by way of example. In this technique, the light sources of successive electronic price tags are controlled so that the light sources of adjacent electronic price tags form a guidance effect that can indicate the desired direction of exit in the premises so that people can follow that direction when exiting in an emergency. Thus, a person who sees the impression of the movement produced by the light sources of the electronic price tags is guided in the direction of the “movement” of the light sources of the electronic price tags. Typically, the impression of movement is obtained by controlling the light sources in groups, where movement is indicated by switching on the next light source and switching off the preceding one. In this way, an impression of movement is created with the light sources, i.e. said impression of movement is created by a “flowing” light. The “moving” light created by the light sources of the electronic price tags can typically be formed, for example, from groups of 3 light sources, where the light of one light source of the electronic price tag is switched on and the other two are switched off. Movement occurs when the light source of the next electronic price tag is turned on and the light source of the preceding electronic price tag is turned off. The impression of movement can also be created by switching the light sources of groups consisting of several electronic price tags alternately on and off. The speed of the movement produced by the light can be adjusted as desired and its direction can also be changed. If an electronic price tag has several light sources, it is also possible to control several light sources of the same electronic price tag to create the movement, i.e. by lighting adjacent light sources of the single electronic price tag in the above-mentioned manner. In one embodiment of the invention, the impression of movement can be created by flashing the light sources of a single electronic price tag and/or by flashing the lights of the light sources of adjacent electronic price tags. In one embodiment of the invention, the above-described light source(s) used in the guidance are light sources separate from the display of the remotely controlled display or electronic price tag, wherein the display of the remotely controlled display or electronic price tag is adapted to present, for example, product-related information, such as price information. Thus, in the example shown in FIG. 3, for example, the light sources 311, 312, 313 of the electronic price tags 331, 332, 333 of the lowest shelves 343 could be controlled as a single group, with the light sources of the respective electronic price tags being turned on and off alternately as described above. And similarly, the light sources of the electronic price tags on the other shelf levels can be controlled in a corresponding manner. After this, the impression of movement can also be extended in a similar way for the adjacent shelves.

In one embodiment of the invention, the system is adapted to implement the guidance of people, such as emergency exit guidance, by flashing guidance light sources of a single remotely controlled display, such as an electronic price tag, so that the flashing produces the impression of movement. In this case, the remotely controlled display, such as an electronic price tag, has several light sources for guidance. In one embodiment of the invention, the system is adapted to implement the guidance of people, such as emergency exit guidance, by flashing the light sources of adjacent remotely controlled displays, such as electronic price tags, so that the flashing of the light sources produces an impression of movement. In this case, a remotely controlled display, such as an electronic price tag, may have one or more light sources used for guidance. In one embodiment of the invention, the guidance function may be implemented as a combination of the above examples.

The light sources of electronic price tags can be controlled by an electronic price tag system or a control system connected to it, the electronic price tag system and/or control system being able to receive signals from one or more fire detectors connected to it, typically installed in many buildings or premises. There exist many different types of fire detectors. One widely used type is the smoke detector, which sends a signal to the control system of smoke generation typical of a fire. Temperature-responsive detectors are also known. In many cases, the fire detectors used have both the characteristics of a smoke detector and a heat detector. Such a fire detector gives a signal of both smoke generation and a temperature which has reached a certain set value. In the event of a fire, smoke spreads over a wide area, so that typically several smoke detectors in fire detectors give an alarm, i.e. a signal. The heat detector, on the other hand, reacts only when the fire is close to the detector, i.e. it reacts more locally to the fire than the smoke detector.

In one embodiment of the invention, the system, such as an electronic price tag system, is adapted to guide people out of the premises, e.g. to the exit and/or emergency exit of the premises, such as the nearest exit door, by flashing the light sources of electronic price tags. The electronic price tag system can guide people using the light sources of electronic price tags on the basis of indications of fire detectors in the premises, e.g. away from the location of a fire detector that has detected a fire. Light sources of electronic price tags arranged side-by-side can be controlled based on a signal from at least one fire detector. In one embodiment of the invention, the guidance function of the system can be activated from the electronic price tag system manually, e.g. by a user of the system.

In one embodiment, the system according to the invention is adapted to operate in such a way that the guidance functionality produced by the light sources of the electronic price tags is activated in a situation where two or more fire detections have been received from a detector arranged in the same premises as the electronic price tags. The activated guidance function can then enter a guidance mode, such as a static guidance mode and/or dynamic guidance mode. If a dynamic guidance mode is used, the guidance effect can be adapted to guide people in the direction of a suitable exit, for example by changing the state of the light sources to create an impression of a “flowing light”, for instance.

In one embodiment of the invention, the location information of the electronic price tags is stored in a system, e.g. a shelf map. In one embodiment of the invention, the electronic price tag system is adapted to generate the flashing order of the light sources of the electronic price tags based on the shelf map of the premises and/or the location information of the electronic price tags.

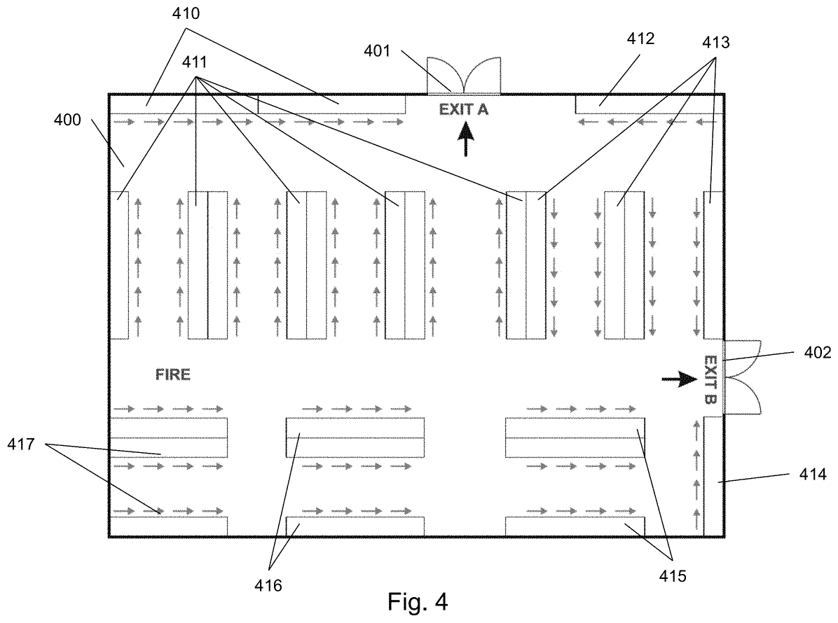

FIG. 4 is a simplified diagram showing the operation of an electronic price tag system according to an embodiment of the invention in the event of a fire in the area. Fire detectors are arranged in premises, such as a store, which can have, for example, both smoke detection and heat detection functionalities. Electronic price tags are arranged on the edges of shelves at the respective products, e.g. on the edges of horizontally and/or vertically adjacent shelves. The premises shown in FIG. 4 have two exits 401 and 402.

The electronic price tags can be arranged to guide people to the nearest available exit. The arrows in the figure illustrate the guidance direction of the electronic price tags. In FIG. 4, the electronic price tags arranged on shelves 411 guide upwards in the figure, i.e. to the part of the premises 400 where an exit 401 is located. Electronic price tags arranged on the shelves 410, 412 arranged peripherally in the premises guide laterally in the figure, directly towards a first exit 401. Electronic price tags arranged on the other shelves 413, 414, 415, 416, 417 guide to the part of the premises where a second entrance 402 is located.

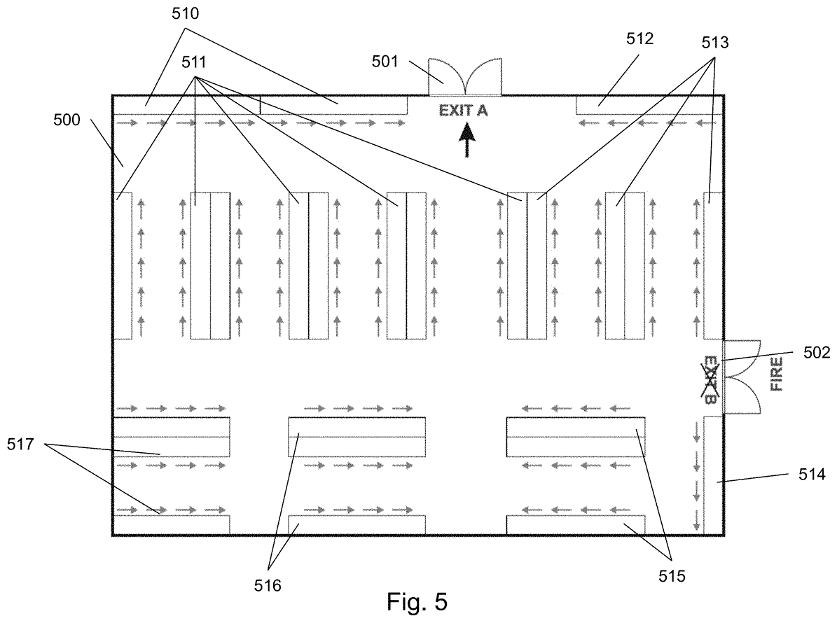

FIG. 5 shows a solution similar to that of FIG. 4, but in the case of FIG. 5 one of the exits in the premises, i.e., in the embodiment of FIG. 5, the second exit 502, is closed or people should not be guided there, for example because of a fire. In FIG. 5, the electronic price tags on the shelves 511, 513 guide upwards in the figure, i.e. to the part of the premises 500 where the first exit 501 is located. Electronic price tags arranged on the shelves 510, 512, 517, 516, 515 guide to the center of the premises. A person guided to the center of the premises can see the guidance of the price tags on the shelves 511 arranged in the center of the premises, pointing directly towards the first exit 501. The guidance of the electronic price tags on the shelf 514 guides away from the second exit 502.

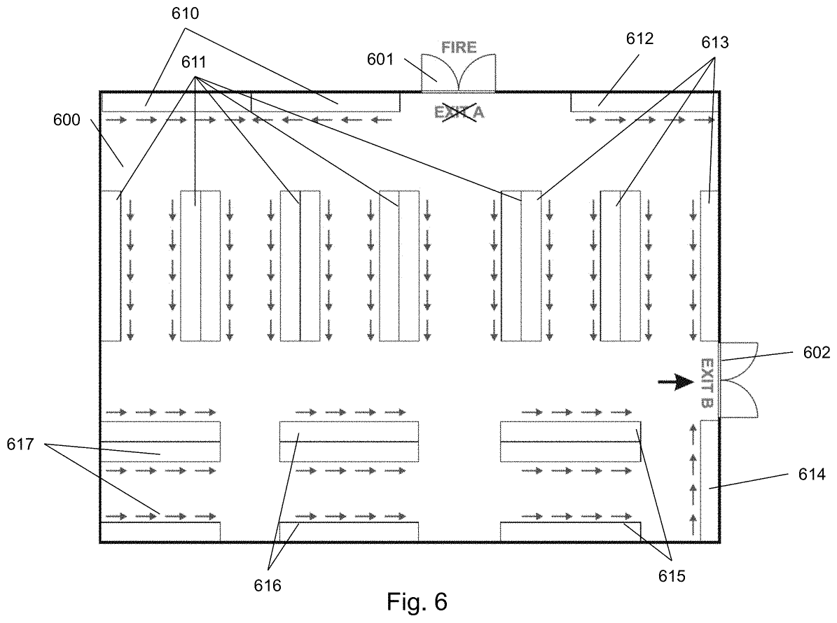

FIG. 6 shows a solution similar to that of FIG. 4 and FIG. 5, but in the case of FIG. 6 one of the exits in the premises, i.e., in the embodiment of FIG. 6, the first exit 601, is closed or people should not be guided there, for example because of a fire. Electronic price tags arranged on the shelves 615, 616, 617 guide to the right in the figure, i.e. to the part of the premises 600 where the second exit 602 is located. Electronic price tags on the shelves 611, 613 guide downwards in the figure, i.e. to the center part of the premises 600. A person guided to the center of the premises can see the electronic price tags on the shelves 615, 616, 617 arranged in the center of the premises, guiding directly towards the second exit 602. The guidance of the electronic price tags arranged on the shelves 612 guides away from the first exit 601. The guidance of the electronic price tags arranged on the shelves 610 guides to the center of the shelf 610, where the guidance of the electronic price tags of the shelves 611 is visible.

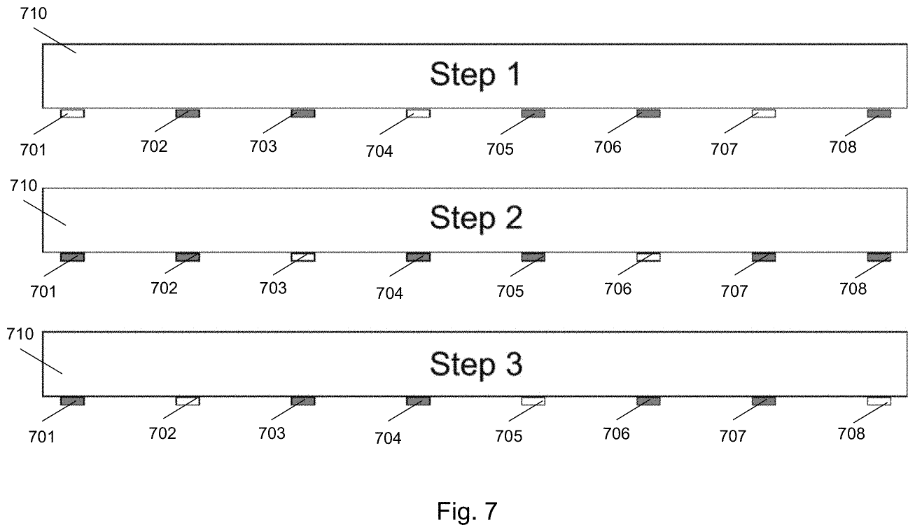

FIG. 7 shows in a simplified diagram the operation of an electronic price tag system according to an embodiment of the invention in a guidance to situation, and how, in one example, the light sources in the electronic price tags can be lit so that the light from the light sources creates an impression of movement. FIG. 7 shows a view of the electronic price tags arranged on the edge of the shelf 710 as seen from above the shelves. In the example of FIG. 7, the impression of movement is produced in such a way that the light sources of two consecutive electronic price tags are lit at each stage and the light source of the electronic price tag between the groups of two price tags is not lit. Going to the next stage, the light sources of the electronic price tags that are lit move forward in the desired guidance direction. In the example of FIG. 7, this means that at the first stage, the light sources of the electronic price tags 702, 703, 705, 706, 708 are lit and the light sources of the electronic price tags 701, 704, 707 are off. At the next stage, the light sources of the electronic price tags that are lit move to the left, i.e. in the desired direction of guidance, which is left in this figure. In the example shown in FIG. 7, this means that at the next stage, the light sources of the electronic price tags 701, 702, 704, 705, 707, 708 are lit and the light sources of the electronic price tags 703, are off. At the next stage, the light sources of the electronic price tags that are lit move further to the left, i.e. in the desired direction of guidance. In the example shown in FIG. 7, this means that at the next stage, the light sources of the electronic price tags 701, 703, 704, 706, are lit and the light sources of the electronic price tags 702, 705, are off. The process can then return to the first stage. This cycle can continue as long as the guidance is to be kept active and the desired guidance direction is to the left.

The above is one example of creating the impression of movement by means of lit light sources of two adjacent electronic price tags, but the impression of movement can also be produced in other ways, e.g. by keeping the light source of one electronic price tag lit and changing the state of the lit light source(s) on the following price tags in the desired direction of guidance.

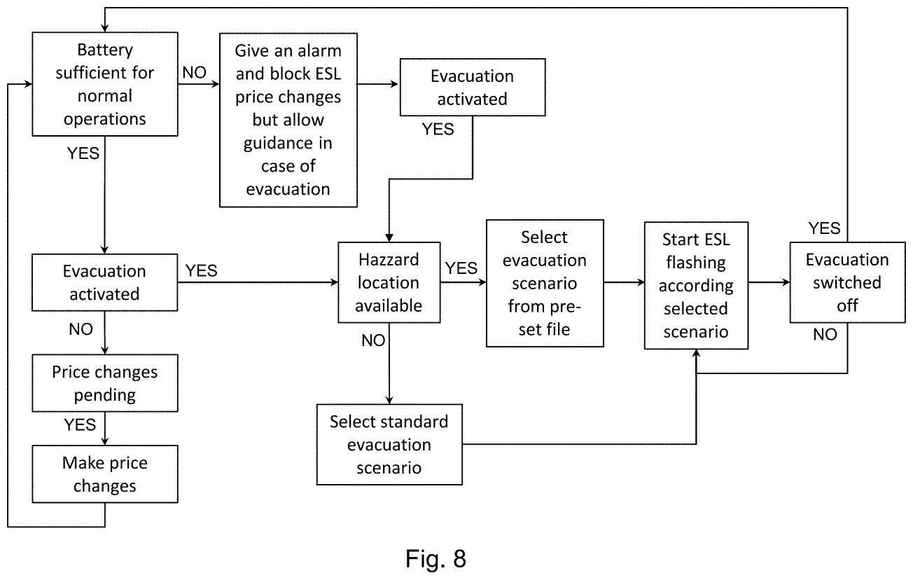

FIG. 8 shows in a block diagram the operation of an electronic price tag system according to the invention. In one embodiment, the electronic price tag system is adapted to function as shown in FIG. 8 in the event of activation of the guidance function. If it is known from which area people need to be evacuated or diverted, e.g. where the fire started or where it was detected, a suitable one of certain predetermined control programs can be selected and activated, whereby the electronic price tag system controls the light sources of the electronic price tags so that people are guided away from a particular area using predefined routes that bypass that area, e.g., the location of the fire or the detector that alerted. If no information is available as to from which area people should be evacuated, a program can be selected and activated to use the light sources of the electronic price tags to guide people so that the entire premises are evacuated along predefined routes.

In a solution according to an embodiment of the invention, the electronic price tag is adapted to indicate the battery level of the electronic price tag to the electronic price tag system, e.g. if the charge decreases below a certain threshold. In a solution according to an embodiment of the invention, the electronic price tag system is adapted to stop updating the price information of the electronic price tag if the battery charge is too low. This saves the battery of the electronic price tag so that the battery will have sufficient charge for exit guidance. In one embodiment of the invention, the minimum charge to be left on the battery of the electronic price tag allows the light source to be used in accordance with the invention for a certain predetermined duration, e.g. one hour. This ensures that the charge level of the electronic price tag will not drop too low, so that guidance can always be provided for at least a certain duration.

In one embodiment of the invention, if the guidance function is active, the electronic price tag system does not update the price information. When the guidance function is switched off, the electronic price tag system can continue to send price information to the electronic price tags.

In one embodiment of the invention, the electronic price tag system comprises or is connected to a light source strip adapted to assist in guidance by guiding in the same direction as the light sources of the electronic price tags.

One embodiment of the invention also relates to an exit guidance system. The system comprises portable devices or the system is connected to portable devices such as mobile telephones, and the system and the devices comprise communication means for communicating with each other. The portable devices comprise software, and a floor plan of the premises is stored in the system and/or software. The system is arranged to implement guidance of people, such as emergency exit guidance, by means of an application installed on portable devices. The floor plan may comprise location information of objects and/or structures in the premises, such as location information of shelves in a store.

In one embodiment of the invention, the exit guidance system is adapted to send an exit command to the device, and, in response to the command, the device is adapted to start exit guidance in the software, shown on the display of the device. The exit command may include information related to the exit guidance, such as the exit route, the exit door, and/or the location of a fire.

In one embodiment of the invention, the exit guidance system and/or software are adapted to guide the user of the device out of the premises, e.g. to the exit and/or emergency exit of the premises, such as the nearest exit door. Using the software in the device, the system can guide people based on indications of fire detectors in the premises, e.g. away from the location of a fire detector that has detected a fire. The system and/or device and/or software may utilize various known positioning systems and techniques, e.g., indoor positioning systems or techniques, to determine the location of the device and/or to modify and adapt guidance based on the location of the device.

In one embodiment of the invention, the exit guidance system and/or software are adapted to generate guidance by showing on the display of the device a route to the exit, wherein the route is adapted to be drawn as a line and/or consecutive and/or adjacent symbols such as dots or circles. The guidance can be performed by making the consecutive and/or adjacent symbols “run”, e.g. by changing their color and/or making the symbols smaller and/or bigger. The symbols may have two states, a normal state and a guidance state, and the impression of motion is created by controlling the symbols in groups so that when the appearance of the next symbol enters the guidance state, e.g. by changing the color and/or making the symbol smaller and/or bigger, the appearance of the preceding symbol enters the normal state.

One embodiment of the invention also relates to an exit guidance method that may be used in an exit guidance system comprising portable devices or the system is connected to portable devices such as mobile telephones, and the system and devices comprise communication means for communicating with each other, wherein the portable devices comprise software, and wherein a map or floor plan of the premises has been stored in the system and/or software. The method implements the guidance of people, such as emergency exit guidance, by means of an application installed on portable devices in the system.

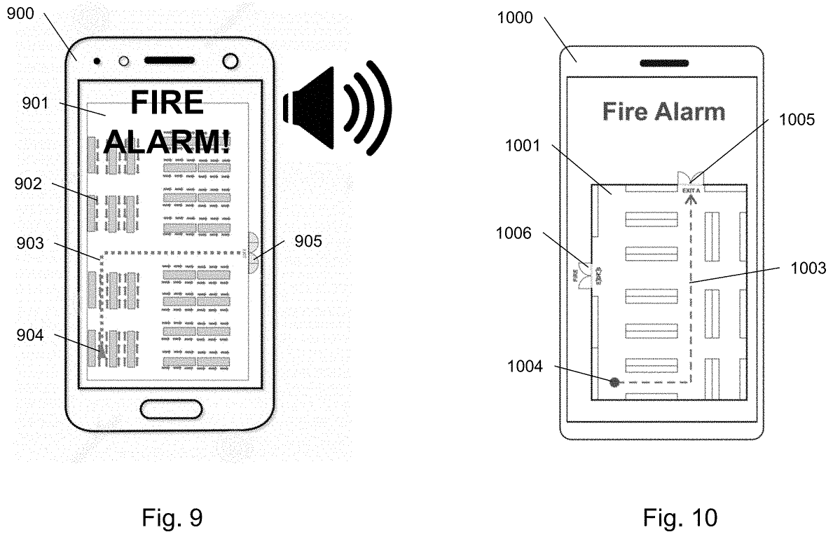

In one embodiment of the invention, the evacuation route may be displayed in an application of a store, sales area or warehouse and the equipment used therein, e.g. a navigation application for the premises or a product collection application used in the store. In one embodiment of the invention, users can check and/or determine the exit route(s) by means of an application on a device. The application can automatically display the evacuation route if evacuation from the premises is initiated and the application is open or opened. FIG. 9 shows an embodiment of such a solution. In the solution of FIG. 9, a device 900 displays a floor plan 901 of the premises by means of software or an installed application. The floor plan may show, for example, the furniture in the premises and/or the layout and/or structures of the premises. The software can also be used to simultaneously display the direction 902 indicated by the guidance signs in the premises. In addition, the software can be used to show on the display of the device the route to exit 903 and the exit 905 and/or the location 904 of the person and/or device in the premises. If the system attempts to enable the exit guidance in the premises, the guidance can be started automatically in one embodiment of the invention on the basis of a command from the system. In this case, the user can be presented a notification of the situation, such as a fire, and/or an audible signal may be emitted. In one embodiment, the system and/or devices may include information about the location of the device. In this case, the guidance is automatically switched on only in devices that are in the premises to be evacuated and/or to which information about the activation of the exit guidance is to be given.

FIG. 10 shows a portable device according to an embodiment of the invention and an application running therein in a fire situation. The solution shown in FIG. 10 otherwise corresponds to the solution shown in FIG. 9, but in the solution of FIG. 10 the software or installed application does not show users the guidance status of the electronic price tags attached to the shelves. In the solution shown in FIG. 10, the premises, e.g. shopping premises, are also different, because in the embodiment of FIG. 9 the premises have a single exit, while in the embodiment shown in FIG. 10 there are two exits: a first exit 1005 and a second exit 1006. FIG. 10 thus shows a device 1000 which displays a floor plan 1001 of the premises by means of software or an installed application. The floor plan may show, for example, the furniture in the premises and/or the layout and/or structures of the premises. The software can be used to show, on a display, the route to exit 1003 as well as the first exit 1005 and the second exit 1006 and/or the location of the person and/or device in the premises.

In one embodiment of the invention, the system comprises a separate guidance display comprising an illuminated sign, such as an arrow sign, and/or light sources. The separate guidance display is adapted to guide in the desired direction by means of the sign and/or light sources. The arrow sign is adapted to change the direction of guidance based on the desired exit direction. In one embodiment of the invention, the separate guidance display is arranged to communicate with a remotely controlled display system, such as an electronic price tag system, and/or in the same way as the displays of the remotely controlled display system. In one embodiment of the invention, the separate guidance display may comprise similar fastening means for attaching the guidance display as the remotely controlled display, such as an electronic price tag. In one embodiment, the separate guidance display is affixed in a manner similar to an electronic price tag, for example on a rail. Separate guidance displays may be provided in addition to other remotely controlled displays, e.g., displays providing static guidance, at necessary intervals and/or in locations where there are no other displays. These locations can be, for example, the ends of shelves, where a person can end up guided by the other displays. In one embodiment of the invention, the separate guidance displays can be arranged at a height of 0 to 1 meter, whereby the display is visible even if there is smoke in the premises. The guidance display can be arranged, for example, on the edge of the lowest and/or second lowest shelf and/or substantially at their height.

With a separate guidance display, the guidance effect can be improved and, for example, in the case of remotely controlled displays for static guidance, dynamic guidance can be easily added to the system by adding separate guidance displays to the system. Since, in one embodiment of the invention, the displays communicate with the system in the same manner as other remotely controlled displays in the system, there is no need to acquire and install any other new components for the system. Using separate guidance displays, it is easy to add dynamic guidance functionality to a remotely controlled display system that uses static guidance light.

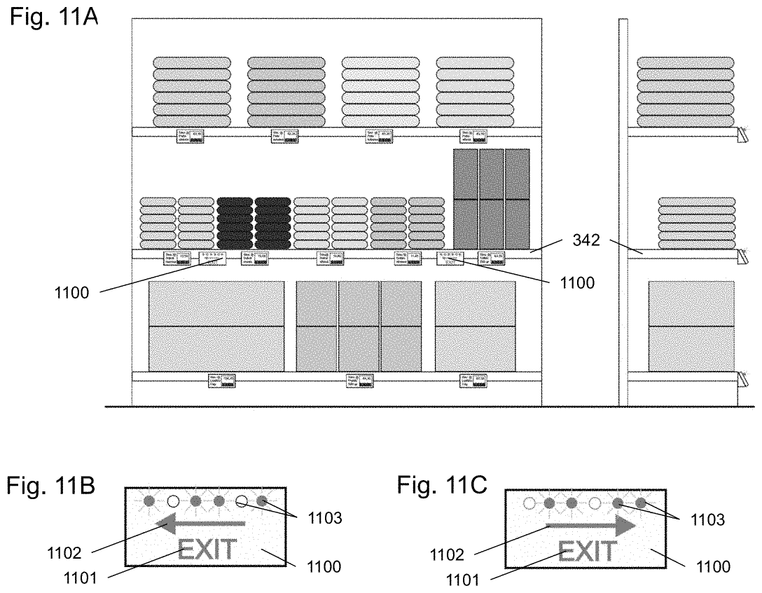

FIG. 11A shows system according an embodiment of the invention comprising separate guidance displays 1100 in addition to the remotely controlled displays. In the embodiment of FIG. 11A, the separate guidance displays are provided at the edges of shelves on the second lowest shelf 342. In other respects, the solution shown in FIG. 11A corresponds to the embodiment shown in FIG. 3.

FIGS. 11B and 11C show a guidance display according to an embodiment of the invention, comprising an illuminated and reversing arrow sign and light sources 1103 for creating the impression of movement in the desired direction of guidance. The light sources 1103 can create the impression of movement in the manner disclosed in the application by turning the light sources on and off in a predetermined manner. Other desired information such as the text EXIT 1101 shown in FIGS. 11B and 11C may also be displayed on the guidance display.

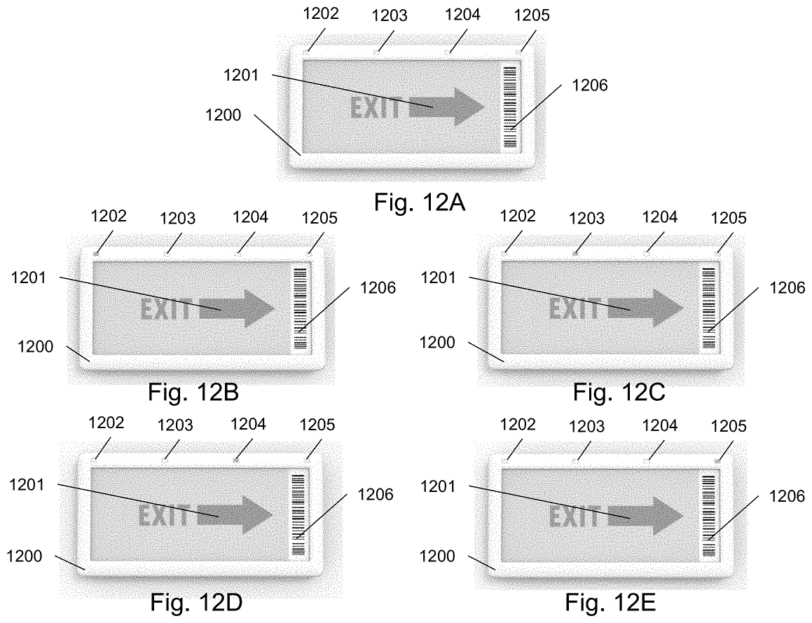

FIGS. 12A-E show a separate guidance display 1200 according to an embodiment of the invention. The separate guidance display comprises an arrow sign 1201 and light sources 1202, 1203, 1204, 1205. FIGS. 12B to 12C show the state of the light sources during guidance. When the guidance is not active, the light sources can remain off as shown in FIG. 12A. In one embodiment of the invention, the arrow sign guiding to the exit route, e.g. the nearest exit door, can remain in the guidance mode and/or visible also in a situation where the emergency exit guidance is not active. Emergency exit guidance can be initiated according to FIG. 12B, i.e. by turning on the first light source 1202. Going to the next step, as shown in FIG. 12C, the second light source is turned on and at the same time the first light source 1202 is turned off. Transition to the next step, as shown in FIG. 12D, takes place in a corresponding fashion, with the second light source 1203 turned off and the third light source 1204 turned on. In the final step, as shown in FIG. 12E, the fourth light source 1205 is turned on and the third light source 1204 is turned off. By repeating this cycle, the guidance can be implemented in the desired direction while the emergency exit guidance remains active. Thus, switching the light sources on and off creates the impression of movement, which in the example of FIGS. 12A to 12E guides to the right. In a similar way, e.g. by reversing the light source control, the guidance can be arranged to the left. The guidance effect with light sources can also be achieved in ways other than those described in the application. The guidance display may also comprise identifier tags, such as a remotely readable identifier tag, for example a barcode 1206 and/or an RFID tag.

In one embodiment of the invention, displays of remotely controlled displays, such as electronic price tags, may be arranged to display arrow signs indicating the desired exit direction. In this way, in an emergency, the display of price information on electronic price tags can be changed to show the direction in which those present in the premises should exit.

In one embodiment of the invention, in the solution of the invention, remotely controlled displays and/or separate guidance displays can also be used to guide people in situations other than emergencies. In one embodiment of the invention, the system and the solution of the invention and the light sources and/or arrow signs can be used to guide persons out of the premises, such as a store, at its closing time or at a certain time before the closing time of the premises.

In one embodiment of the invention, the system may be adapted to activate guidance at a certain time, for example at a certain day and at a certain time of day. Guidance can also be activated manually by the user. The destination of guidance can be, for example, the nearest exit and/or the nearest checkout. In this way, the system can indicate to people in the premises, for example a store, that the premises are about to be closed and guide people in the right direction of exit by means of remotely controlled displays and/or separate guidance displays and their light sources and/or arrow signs.

It will be apparent to those skilled in the art that the various embodiments of the invention are not limited to the examples set forth above, and may therefore vary within the scope of the claims set forth below. If necessary, features presented in the description together with other features may also be applied separately from each other.

1. A remotely controlled display system, such as an electronic price tag system, wherein the system comprises:
at least one base station; and
a plurality of remotely controlled displays, such as electronic price tags, the displays being arranged in premises, such as a store, and comprising a light source, e.g. an LED light source,
wherein the system is adapted to provide guidance to people, such as emergency exit guidance, by turning on and/or off the light sources of the displays in a pre-determined manner.

2. The system of claim 1, wherein the system is adapted to switch on and keep lit the light sources of the remotely controlled displays when the premises need to be evacuated, e.g. based on an indication by fire detectors.

3. The system of claim 1, wherein the system is adapted to flash the light sources of adjacent remotely controlled displays so that the light sources create the impression of movement.

4. The system of claim 1, wherein the system is adapted to create the impression of movement by controlling the light sources of the remotely controlled displays in groups such that when the light source of the next remotely controlled display or the light sources of the next group of a plurality of remotely controlled displays are switched on, the light source of the previous remotely controlled display or the light sources of the previous group of remotely controlled displays are switched off.

5. The system of claim 1, wherein the system is adapted to guide people out of the premises, e.g. to the exit and/or emergency exit of the premises, such as the nearest exit door, by flashing the light sources of remotely controlled displays.

6. The system of claim 1, wherein the system is adapted to guide people by the light sources of remotely controlled displays on the basis of indications of fire detectors in the premises, e.g. away from the location of a fire detector that has detected a fire.

7. The system of claim 1, wherein the system is adapted to generate the guiding flashing sequence of the light sources of the remotely controlled displays based on a shelf map of the premises and/or location information of the remotely controlled displays.

8. The system of claim 1, wherein the system is adapted to provide guidance by means of substantially all remotely controlled displays in the premises or part of the premises, or only the remotely controlled displays located on the lowest level of the premises or part of the premises, such as the lowest shelves.

9. The system of claim 1, wherein the remotely controlled display is adapted to inform the system of the battery level of the remotely controlled display, e.g. if the level drops below a certain charge level, and/or the system is adapted to stop updating information, such as price information, on the remotely controlled displays if the battery charge is too low.

10. The system of claim 1, wherein the system comprises or is connected to a light source strip adapted to assist in guidance by guiding in the same direction as the light sources of the remotely controlled displays.

11. The system of claim 1, wherein the system comprises a separate guidance display comprising an illuminated sign, such as an arrow sign, and/or light sources, the separate guidance display being adapted to guide in the desired direction by means of the sign and/or light sources.

12. The system of claim 11, wherein the separate guidance display is arranged to communicate with a remotely controlled display system, such as an electronic price tag system, in the same way as the remotely controlled displays.

13. A method of controlling remotely controlled displays, such as electronic price tags, of a remotely controlled display system, such as an electronic price tag system, wherein the system comprises at least one base station and a plurality of remotely controlled displays, such as electronic price tags, the remotely controlled displays being arranged in premises, such as a store, and comprising a light source, e.g. an LED light source,
wherein the method comprises the system providing guidance to people, such as emergency exit guidance, by turning on and/or off the light sources of the remotely controlled displays in a pre-determined manner.

14. The method of claim 13, wherein the system switches on and keeps lit the light sources of the remotely controlled displays when the premises need to be evacuated, e.g. based on an indication by fire detectors.

15. The method of claim 13, wherein the system flashes the light sources of adjacent remotely controlled displays so that the light sources create the impression of movement.

16. The method of claim 13, wherein the impression of movement is created by controlling the light sources of the remotely controlled displays in groups such that when the light source of the next remotely controlled display or the light sources of the next group of a plurality of remotely controlled displays are switched on, the light source of the previous remotely controlled display or the light sources of the previous group of a plurality of remotely controlled displays are switched off.

17. The method of claim 13, wherein people are guided out of the premises, e.g. to the exit and/or emergency exit of the premises, such as the nearest exit door, by the flashing of the light sources of remotely controlled displays.

18. The method of claim 13, wherein the system guides people by the light sources of remotely controlled displays on the basis of indications of fire detectors in the premises, e.g. away from the location of a fire detector that has detected a fire.

19. The method of claim 13, wherein the system generates the guiding flashing sequence of the light sources of the remotely controlled displays based on a shelf map of the premises and/or location information of the remotely controlled displays.

20. The method of claim 13, wherein the system provides guidance by means of substantially all remotely controlled displays in the premises or part of the premises, or only the remotely controlled displays located on the lowest level of the premises or part of the premises, such as the lowest shelves.

21. The method of claim 13, wherein the remotely controlled display informs the system of the battery level of the remotely controlled display, e.g. if the level drops below a certain charge level, and/or the system stops updating information, such as price information, on the remotely controlled displays if the battery charge is too low.

22. The method of claim 13, wherein the system comprises or is connected to a light source strip which assists in guidance by guiding e.g. in the same direction as the light sources of the remotely controlled displays.

23. The method of claim 13, wherein the system comprises a separate guidance display comprising an illuminated sign, such as an arrow sign, and/or light sources, the separate guidance display guiding in the desired direction by means of the sign and/or light sources.

24. The method of claim 23, wherein the separate guidance display communicates with a remotely controlled display system, such as an electronic price tag system, in the same way as the remotely controlled displays.
